(19) United States
(12) Patent Application Publication
(10) Pub. No.: US 2007/0284848 A1
(43) Pub. Date: Dec. 13, 2007

(54) Drag-reducing structure

(75) Inventor: Leonard Willliam Brownlie, West Vancouver (CA)

Correspondence Address: BANNER & WITCOFF, LTD., 1100 13th STREET, N.W., SUITE 1200, WASHINGTON, DC, 20005-4051, US

(73) Assignee: NIKE, Inc., Beaverton, OR (US)

(21) Appl. No.: 11/439,375

(22) Filed: May 23, 2006

(51) Int. Cl. B62K 3/00

(52) U.S. Cl. 280/288.1

(57) ABSTRACT

A drag-reducing structure for athletic equipment and other products is disclosed. The structure includes a substantially cylindrical portion and a plurality of turbulence generators secured to the cylindrical portion. The cylindrical portion is substantially perpendicular to a direction of fluid movement, and the cylindrical portion has a leading edge oriented toward the direction of fluid movement. Each of the turbulence generators may have a V-shaped configuration with a point that is oriented toward the leading edge, or the turbulence generators may have another configuration. At least a portion of the turbulence generators are located in a range of 50 degrees and 90 degrees from the leading edge.

### BACKGROUND

Many athletic competitions revolve around the velocity of an athlete. As examples, running, bicycling, swimming, and skiing competitions are based upon velocity, and the athlete achieving the greatest average velocity,will generally prevail in the competition. One factor that limits or otherwise has a effect upon the velocity of the athlete relates to drag forces caused by fluid (i.e., gas or liquid) flowing around the athlete and equipment utilized by the athlete. As the velocity of the athlete increases, drag forces also increase and effectively limit the velocity of the athlete. In order to enhance the performance of the athlete, apparel and equipment utilized by the athlete may be designed to induce relatively low drag forces, thereby permitting the athlete to achieve a greater average velocity. That is, by designing athletic equipment and apparel to minimize drag forces, the velocity of the athlete may be increased to provide a competitive advantage.

Drag forces upon a body (e.g., the apparel and equipment) include two components: frictional drag and form drag. Frictional drag arises due to the viscosity of the fluid passing around the body and is produced by viscous shear in layers of the fluid immediately adjacent the body. In general, frictional drag is proportional to the total surface area of the body exposed to the fluid. Form drag arises due to a disturbance (i.e., wake) created by the body and is generally a function of the shape of the body.

When a stream of fluid flows past a body, at least a portion of the fluid flow is disturbed or otherwise altered by the body and forms a boundary layer (i.e., the region of disturbed fluid). Immediately adjacent a surface of the body, the fluid has a tangential velocity (i.e., velocity parallel to the surface) of zero. The tangential velocity increases throughout a thickness of the boundary layer, and the tangential velocity achieves the velocity of the free stream at the edge of the boundary layer. Accordingly, the fluid velocity effectively increases throughout the boundary layer as distance away from the body increases.

The boundary layer exhibits laminar flow when the fluid flow proceeds as if it were made up of laminate sliding smoothly over each other. If there are irregular motions in the layers, and the motions are normal to the surface of the body, then the boundary layer exhibits turbulent flow. In general, laminar flow exists for relatively low Reynolds numbers (e.g., below 5×10⁵) and turbulent flow arises at relatively high Reynolds numbers (e.g., above 5×10⁷), with a transition region in between.

A combination of frictional drag and form drag forms the total drag force (F_{D}), which is a function of the drag coefficient (C_{D}), dynamic pressure (q), and projected area (S) of a body. More particularly, F_{D}=(C_{D})·(q)·(S). When a fluid flows around a body with a spherical, cylindrical, or ellipsoidal shape, the drag coefficient depends upon various factors, including the Reynolds number, surface roughness of the body, and turbulence in the air stream. With regard to laminar flow (i.e., low Reynolds numbers), the frictional drag is relatively low, but the boundary layer has a tendency to separate from the body at a location that forms a relatively wide wake, thereby inducing a relatively large form drag because flow separation limits pressure recovery along the downstream portion of the body. With regard to turbulent flow (i.e., high Reynolds numbers), the frictional drag is greater, but the boundary layer tends to separate from the body at a more rearward location to form a relatively narrow wake, thereby inducing a relatively low form drag. In general, the drag coefficient for laminar flow is greater than the drag coefficient for turbulent flow. Accordingly, in situations where all other factors are substantially equal (e.g., dynamic pressure and projected area), turbulent flow will generally result in a lesser total drag force.

Relatively low drag forces may be produced by inducing turbulent flow on forward portions of a body. One method of increasing turbulence and reducing the drag force upon a body relates to the use of turbulence generators. As noted above, turbulent flow will generally result in a lesser total drag force than laminar flow. When a fluid flows over a turbulence generator, the flow of the fluid is disrupted, thereby increasing the turbulent aspects of the fluid flow and decreasing the drag force. The concept of utilizing turbulence generators to reduce drag forces upon apparel, for example, is disclosed in U.S. Pat. No. 5,734,990 to Waring and U.S. Pat. No. 5,033,116 to Itagaki, et al. Similarly, the concept of utilizing turbulence generators to reduce drag forces upon airplane wings (i.e., air foils), automobiles, and the sails and keel of a boat, for example, are disclosed in U.S. Pat. No. 5,058,837 to Wheeler.

### SUMMARY

One aspect of the invention is an article including a substantially cylindrical substrate and a plurality of turbulence generators secured to an exterior surface of the substrate. The substrate has a longitudinal axis that is substantially perpendicular to a direction of fluid movement, and the exterior surface of the substrate has a leading edge oriented toward the direction of fluid movement and an opposite trailing edge. At least a portion of the turbulence generators are located in a range of 50 degrees and 90 degrees from the leading edge. In some configurations, the turbulence generators may have a V-shaped or triangular configuration.

The substrate may be a portion of an article of athletic equipment, such as a bicycle (e.g., a frame of the bicycle), a baseball bat, or a golf club. In some aspects of the invention, the turbulence generators may include a first row of the turbulence generators and a second row of the turbulence generators, and the first row and the second row may be located on opposite sides of the substrate. The turbulence generators may also be joined together or located at 70 degrees from the leading edge. In some aspects of the invention the substrate may have an elliptical cross-section.

Another aspect of the invention is a method of reducing a drag force. The method includes providing a substantially cylindrical body with a longitudinal axis. The body is oriented such that the longitudinal axis forms an angle less than 30 degrees with a plane that is perpendicular to a direction of fluid flow. A plurality of turbulence generators are secured to a surface of the cylindrical body. In addition, the turbulence generators are located within a range of 50 degrees and 90 degrees from the leading edge.

The advantages and features of novelty characterizing various aspects of the invention are pointed out with particularity in the appended claims. To gain an improved understanding of the advantages and features of novelty, however, reference may be made to the following descriptive matter and accompanying drawings that describe and illustrate various embodiments and concepts related to the aspects of the invention.

### DESCRIPTION OF THE DRAWINGS

The foregoing Summary, as well as the following Detailed Description, will be better understood when read in conjunction with the accompanying drawings.

FIG. 1 is an elevational view of a bicycle in accordance with various aspects of the invention.

FIG. 2A is a first elevational view of a portion of the bicycle that includes a plurality of turbulence generators.

FIG. 2B is a second elevational view of an opposite side of the portion of the bicycle depicted in FIG. 2A.

FIGS. 2C and 2D are cross-sectional views of the portion of the bicycle, as respectively defined by section lines 2C and 2D in FIG. 2A.

FIGS. 3A-3E depict various turbulence generator configurations for the portion of the bicycle.

FIGS. 3F-3I are perspective views of various additional turbulence generator configurations.

FIGS. 4A-4C are cross-sectional views corresponding with FIG. 2C and depict further turbulence generator configurations for the portion of the bicycle.

FIGS. 5A-5C depict additional turbulence generator configurations for the portion of the bicycle.

FIG. 6A is an elevational view of a baseball bat in accordance with various aspects of the invention.

FIG. 6B is an elevational view of a golf club in accordance with various aspects of the invention.

FIG. 6C is a side elevational view of a vehicle in accordance with various aspects of the invention.

FIG. 6D is a side elevational view of a portion of an airplane in accordance with various aspects of the invention.

FIG. 6E is a side elevational view of a pier in accordance with various aspects of the invention.

### DETAILED DESCRIPTION

The following discussion and accompanying figures disclose drag-reducing turbulence generators. Concepts related to the turbulence generators are discussed below with reference to various articles of athletic equipment, including a bicycle, a baseball bat, and a golf club, but may also be applied to a variety of other types of athletic equipment. The turbulence generators are not limited to applications relating to athletic equipment, however, and may be incorporated into a plurality of other applications, including various motorized vehicles (e.g., motorcycles, cars, trucks, airplanes, boats), non-motorized vehicles (e.g., soap-box derby cars, gliders, hang-gliders, sailboats), and columns that support bridges and piers, for example. Accordingly, concepts associated with the turbulence generators may be applied to a variety of consumer and non-consumer products to reduce drag forces.

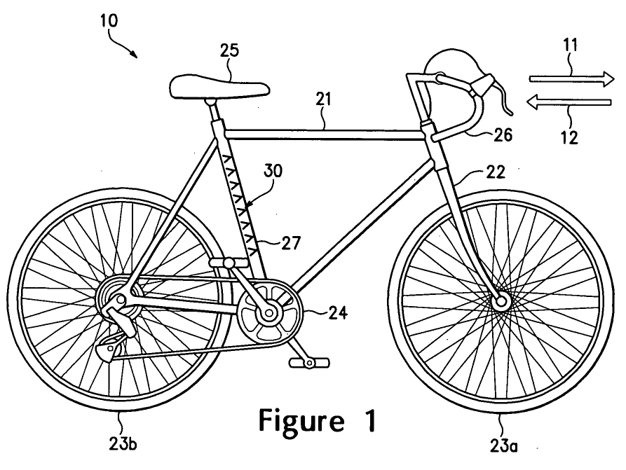

A bicycle 10 having the general configuration of a road bike is disclosed in FIG. 1. The primary components of bicycle 10 are a frame 21, a fork 22, a pair of wheels 23a and 23b, a drive mechanism 24, a seat 25, and handlebars 26. As recognized by one skilled in the relevant art, bicycle 10 moves under the power and control of an individual. More particularly, the individual utilizes drive mechanism 24 to pedal, changes gears, and brake, thereby controlling the velocity of bicycle 10. In addition, the individual rotates handlebars 26 to induce rotation of fork 22 and wheel 23a, thereby steering and controlling the direction that bicycle 10 moves. Based upon the above discussion, bicycle 10 has a generally conventional configuration and operates in a generally conventional manner. In contrast with a conventional bicycle, however, bicycle 10 includes a plurality of turbulence generators 30 secured to a seat tube portion 27 of frame 21.

As bicycle 10 moves in a forward direction (i.e., a direction represented by an arrow 11), air that flows past bicycle 10 induces a drag force upon bicycle 10 in a rearward direction (i.e., a direction represented by an arrow 12). As a velocity of bicycle 10 increases, the overall drag force upon bicycle 10 also increases in relation to the velocity increase. Accordingly, the drag force will be less at lower velocities and greater at higher velocities. Turbulence generators 30, however, decrease the overall drag force upon bicycle 10. That is, the drag force in the direction of arrow 12 will be decreased due to the action of turbulence generators 30. In comparison with a substantially-similar bicycle that does not include turbulence generators 30, bicycle 10 may have an advantage of an increase in velocity due to the action of turbulence generators 30 and the corresponding decrease in drag force.

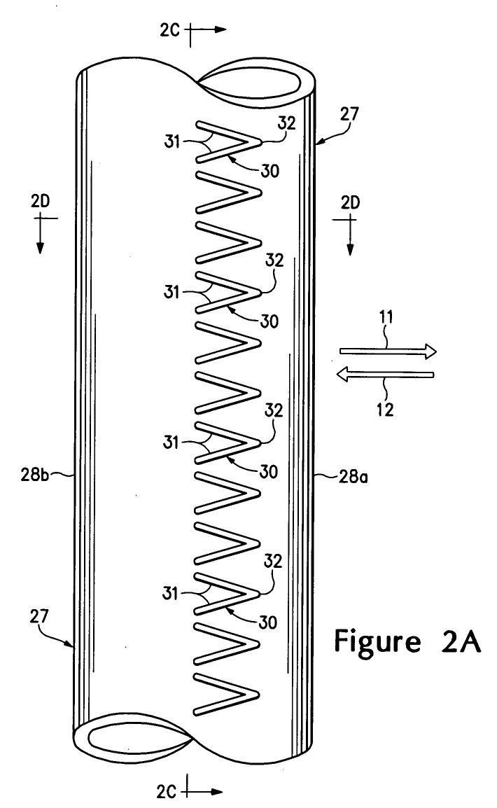

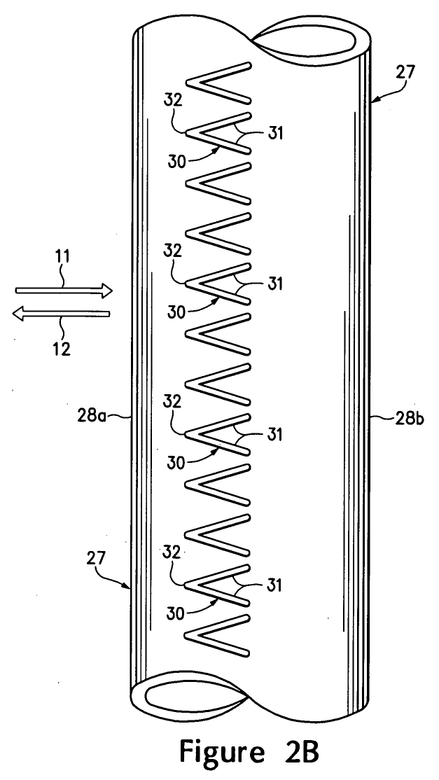

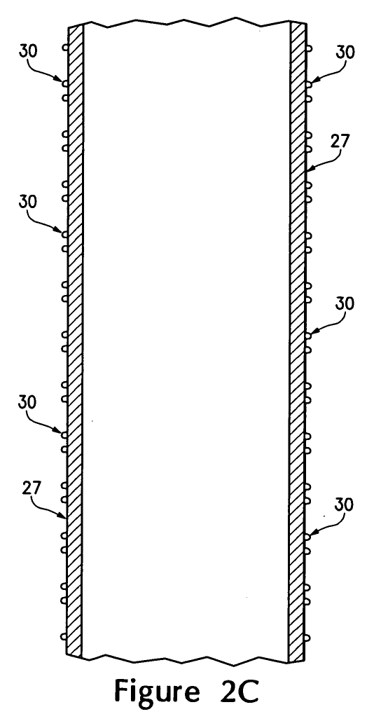

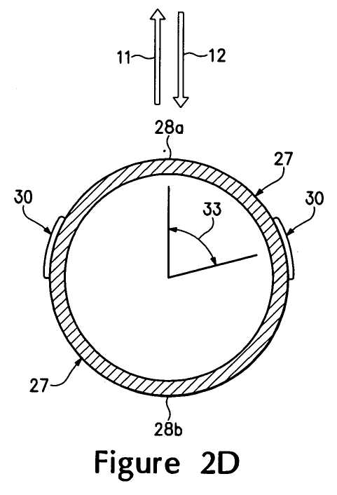

Detailed concepts regarding turbulence generators 30 will now be discussed. A section of seat tube portion 27, which includes various turbulence generators 30, is depicted in FIGS. 2A-2D. For purposes of reference, arrow 11 is depicted to demonstrate the direction that bicycle 10 (i.e., seat tube portion 27) moves, and arrow 12 is depicted to demonstrate the direction of air flow and the corresponding direction of the drag force on seat tube portion 27. Also for purposes of reference, a leading edge 28a and a trailing edge 28b are depicted. Leading edge 28a defines the area of seat tube portion 27 that faces into the direction of air flow, whereas trailing edge 28b is the area of seat tube portion 27 that faces the direction of air flow.

Turbulence generators 30 each have a V-shaped configuration formed from two segments 31 that join at a point 32. Each of points 32 are oriented to point in the general direction of leading edge 28a (i.e., into the direction of air flow). Two rows of turbulence generators 30 extend along opposite sides of seat tube portion 27. That is, a first row of turbulence generators 30 extends along one side of seat tube portion 27, as shown in FIG. 2A, and a second row of turbulence generators 30 extends along an opposite side of seat tube portion 27, as shown in FIG. 2B. Accordingly, when a stream of moving air contacts seat tube portion 27 at leading edge 28a, the stream is split by seat tube portion 27 such that one portion of the air stream passes over one row of turbulence generators 30 and another portion of the air stream passes over another row of turbulence generators 30. Segments 31 are depicted in FIG. 2C as having a semi-circular cross-sectional shape. In further aspects of the invention, the cross-sectional shape of segments 31 may be rectangular or square, for example, or the cross-sectional shape my have any other practical configuration.

The primary purpose of turbulence generators 30 is to reduce the drag force upon bicycle 10. In general, turbulence generators 30 increase the degree of turbulence in the air flowing over seat tube portion 27, which results in a lesser total drag force. More particularly, an increase in the turbulence of the air decreases the drag coefficient associated with seat tube portion 27. For most bodies in a fluid stream, the drag coefficient associated with turbulent flow is relatively constant over a range of dynamic pressures velocities. That is, the drag coefficient for turbulent flow is effectively independent of the fluid velocity. An advantageous aspect to the configuration disclosed herein, however, is that the drag coefficient decreases as the fluid velocity increases. More particularly, the drag coefficient has been found to decrease with increasing air velocity in configurations where turbulence generators 30 are (a) located in a range of 50 degrees and 90 degrees from a leading edge of a body and (b) positioned on a substantially cylindrical body that is oriented substantially parallel to the direction of air movement. With respect to bicycle 10 and set tube portion 27, each of these aspects will be discussed in greater detail below.

Turbulence generators 30, as depicted in FIG. 2D, are located in a range of 50 degrees and 90 degrees from leading edge 28a of seat tube portion 27. More particularly, each row of turbulence generators 30 are located at a position that is offset from leading edge 28a by approximately 70 degrees. That is, an angle 33 formed by a first line that extends from a center of seat tube portion 27 to leading edge 28a and also formed by a second line that extends from the center to turbulence generators 30 is approximately 70 degrees. For rounded bodies, such as cylinders and ellipsoids, laminar flow may separate from the bodies at a position of approximately 83 degrees to form a wake. By placing turbulence generators 30 at a position of approximately 70 degrees from leading edge 28a, turbulence generators 30 are located upstream from the position where laminar flow separates from seat tube portion 27.

Seat tube portion 27 has a substantially cylindrical configuration in areas where turbulence generators 30 are located. As utilized herein, the term “substantially cylindrical” is defined as an elongate structure having a cross-section with a circular or elliptical configuration. Seat tube portion 27 also has a substantially perpendicular orientation relative to the direction of air movement (i.e., the direction represented by arrow 12). As utilized herein, the term “substantially perpendicular” is defined as being within 30 degrees of a plane that is normal to a direction of air movement.

Turbulence generators 30 are depicted as being positioned on seat tube portion 27 of frame 21, which provides an example of a suitable location on bicycle 10 for turbulence generators 30. In addition to seat tube portion 27, turbulence generators 30 may be located on (a) a forward portion of frame 21, which receives fork 22 and handlebars 26, (b) a support for seat 25, which protrudes outward from seat tube portion 27, (c) a portion of fork 22 extending along opposite sides of wheel 23a, and (d) portions of handlebars 26, for example. Each of these locations are suitable due to their substantially perpendicular orientation relative to the direction of air movement and the substantially cylindrical configuration.

The direction defined by arrow 12 represents the direction of air movement for a majority of the components of bicycle 10. Some portions of bicycle 10 that rotate or otherwise change orientation may, however, experience other directions of air movement. For example, the spokes of wheels 23a and 23b and the cranks associated with the pedals of drive mechanism 24 may experience air movement in directions that are different than the direction defined by arrow 12. In general, however, the spokes and cranks have a substantially perpendicular orientation relative to the direction of air movement that passes over each individual spoke and crank. Accordingly, turbulence generators 30 may also be located on the spokes of wheels 23a and 23b and the cranks associated with drive mechanism 24 because of their substantially perpendicular orientation relative to the direction of air movement and the substantially cylindrical configuration in the areas where turbulence generators 30 are located.

A bicycle, such as bicycle 10, may be retrofitted to incorporate turbulence generators 30, or the bicycle may be specifically designed to incorporate turbulence generators 30. When the bicycle is retrofitted, turbulence generators 30 may be applied to any location having a substantially perpendicular orientation and a substantially cylindrical configuration. For example, turbulence generators 30 may have an adhesive backing that facilitates securing turbulence generators 30 to various components of the bicycle. When a bicycle is not specifically designed to incorporate turbulence generators 30, components of the bicycle that have a substantially perpendicular orientation may not also have a substantially cylindrical configuration. For example, the fork and cranks associated with some conventional bicycles may not be shaped to have a substantially cylindrical configuration. An advantage to specifically designing a bicycle to incorporate turbulence generators 30 is that components such as the fork and cranks may be shaped to exhibit a substantially cylindrical configuration. Another advantage to specifically designing a bicycle is that some of turbulence generators 30 may be formed of unitary (i.e., one-piece) construction with components of the bicycle. That is, turbulence generators 30 may be formed during a machining or molding process that forms components of the bicycle. Although turbulence generators 30 may be formed of unitary construction with components when the bicycle is specifically designed to incorporate turbulence generators 30, turbulence generators 30 may also be formed separately and applied (e.g., with an adhesive) following manufacture of the individual components.

As discussed in the Background section above, the total drag force (F_{D}) is a function of the drag coefficient (C_{D}), dynamic pressure (q), and projected area (S) of a body, such as bicycle 10, and the total drag force is calculated by F_{D}=(C_{D})·(q)·(S). The drag coefficient for laminar flow is generally greater than the drag coefficient for turbulent flow. Accordingly, turbulent flow will generally result in a lesser total drag force than laminar flow when the dynamic pressure and projected area are substantially equal between the turbulent flow and laminar flow scenarios. That is, for a given dynamic pressure and projected area, the total drag force exerted upon bicycle 10 will be less when the fluid exhibits turbulent flow rather than laminar flow. Turbulence generators 30 form vortices in the fluid flowing around bicycle 10, particularly seat tube portion 27. The vortices effectively mix fluid from one fluid layer with fluid from another fluid layer, thus increasing the turbulence of the flowing fluid. Given that drag coefficients for turbulent flow are less than drag coefficients for laminar flow, the overall drag force upon bicycle 10 is effectively reduced by the presence of turbulence generators 30.

Given that turbulence generators 30 increase the turbulence of downstream flow, the point at which the air flow separates from seat tube portion 27 may move toward trailing edge 28b. By moving the point at which the air flow separates from seat tube portion 27 toward trailing edge 28b, the frictional drag on seat tube portion 27 may increase, but the form drag will decrease to a greater degree, thereby decreasing the overall drag force upon seat tube portion 27.

The drag coefficients for a body in a fluid stream are generally higher for laminar flow than for turbulent flow. Despite the lower drag coefficients for turbulent flow, the drag force upon the body is generally greater for turbulent flow due to an increase in dynamic pressure from a corresponding increase in flow velocity. In contrast with the drag coefficients for bodies that do not incorporate turbulence generators 30, an advantageous aspect to the configuration disclosed herein is that the drag coefficient decreases as the fluid velocity increases. More particularly, the drag coefficient has been found to decrease with increasing air velocity in configurations where turbulence generators 30 are (a) located in a range of 50 degrees and 90 degrees from leading edge 28a of seat tube portion 27 and (b) positioned on a substantially cylindrical area of seat tube portion 27 that is oriented substantially parallel to the direction of air movement (i.e., the direction of arrow 12).

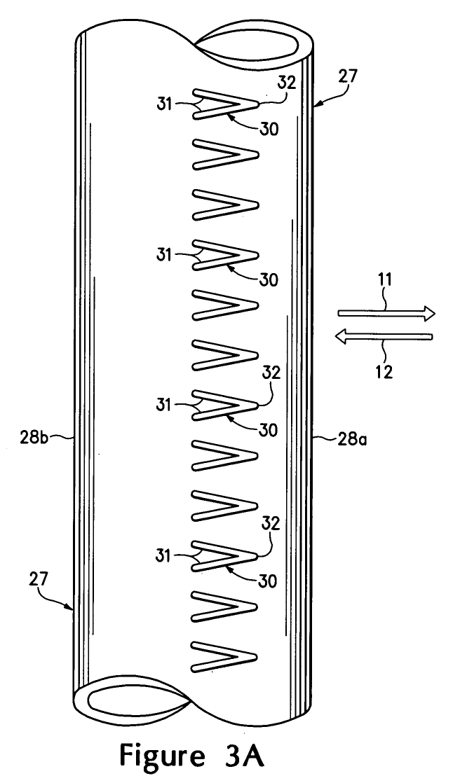

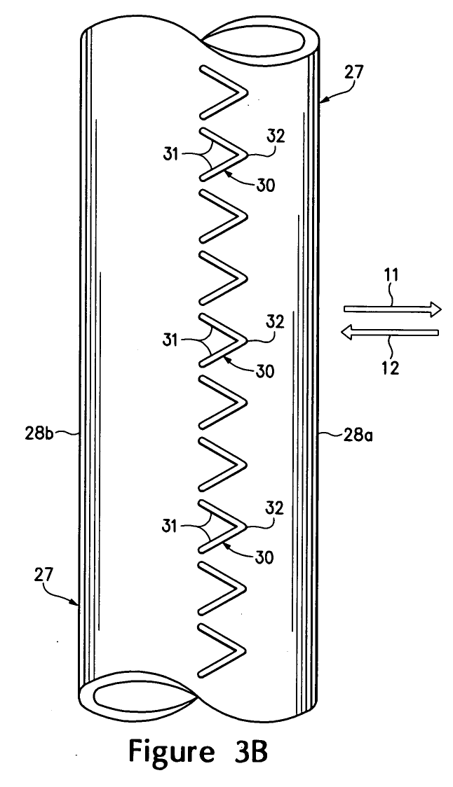

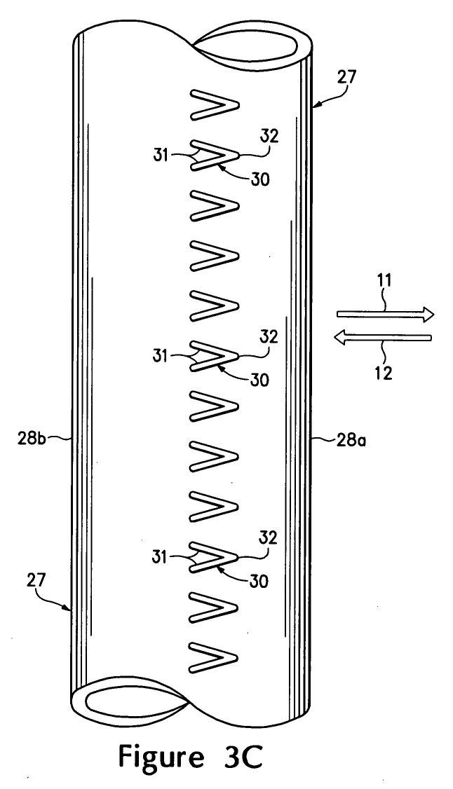

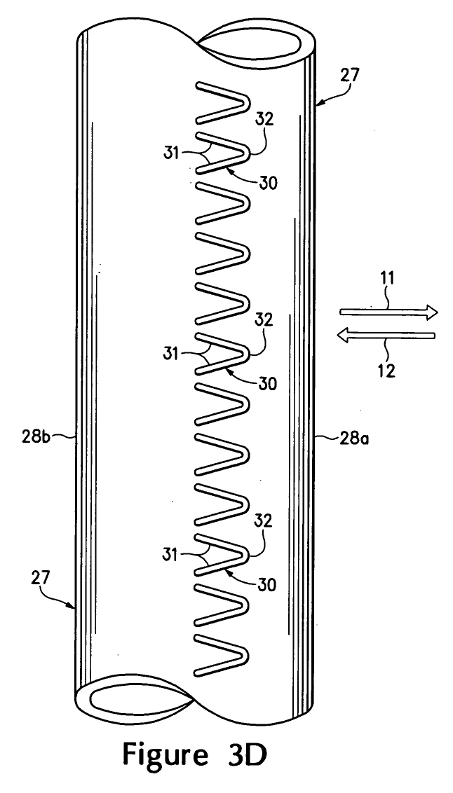

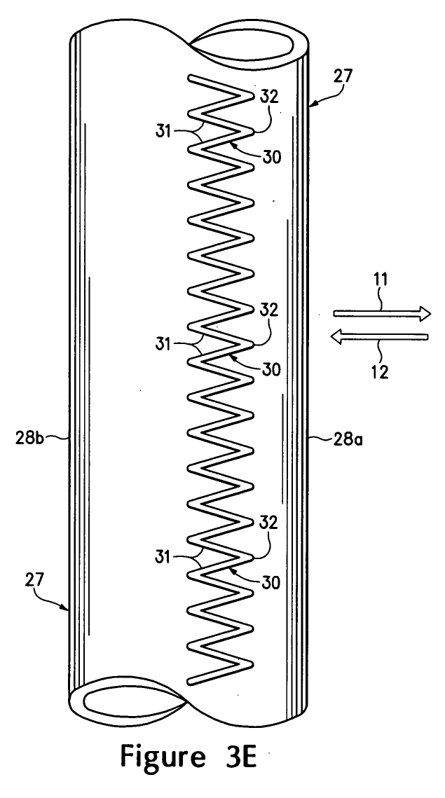

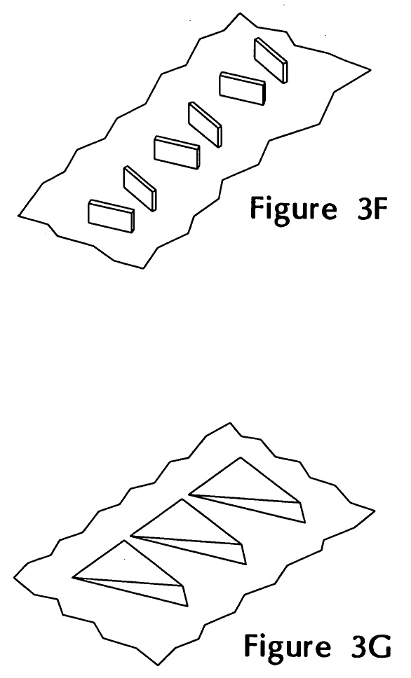

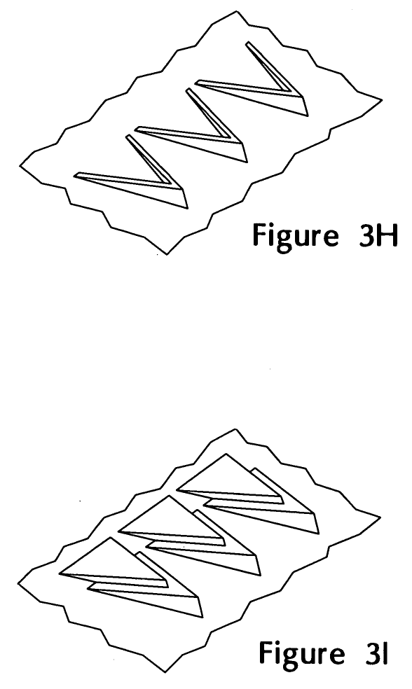

Although the configuration of turbulence generators 30 depicted in FIGS. 2A-2D is suitable for purposes of the present invention, a variety of other turbulence generator configurations may also be utilized. With reference to FIGS. 3A-3C, turbulence generators 30 are respectively depicted in various configurations that include a decrease in the angle formed by segments 31, an increase in the angle formed by segments 31, and an overall size reduction. In some configurations, point 32 may also have a rounded configuration, as depicted in FIG. 3D. Whereas turbulence generators 30 may be individual elements that are secured to seat tube portion 27, as depicted in FIGS. 2A and 2B, rearward portions of segments 31 may also be joined to form a unitary strip of turbulence generators 30, as depicted in FIG. 3E. That is, a plurality of turbulence generators 30 may be formed as a zigzag shape in some configurations. Accordingly, the overall shape and configuration of turbulence generators 30 may vary significantly within various aspects of the invention.

The configuration of turbulence generators 30 that is depicted in FIGS. 1-3E exhibit a V-shaped configuration and are generally referred to as Kuethe-type vortex generators. A variety of other vortex generator configurations may also be utilized. For example, turbulence generators 30 may be vane-type vortex generators, as depicted in FIG. 3F, which have the shape of rectangular or triangular plates mounted perpendicular to a surface and canted to the direction of fluid flow. Stephens-type vortex generators, which are depicted in FIG. 3G as having a triangular and tapered configuration, are also suitable for turbulence generators 30. Furthermore, turbulence generators 30 may be Wheeler-type vortex generators, which include configurations with either a V-shaped structure or overlapped triangular plates, as depicted in FIGS. 3H and 3I. Whereas Kuethe-type vortex generators are generally oriented such that the point faces the leading edge, Stephens-type vortex generators and Wheeler-type vortex generators may be oriented such that the point is oriented toward the trailing edge. The orientation of vortex generators 30 may, therefore, depend upon the type of vortex generators that is utilized. Accordingly, a variety of turbulence generator configurations and orientations may be utilized within the scope of the invention.

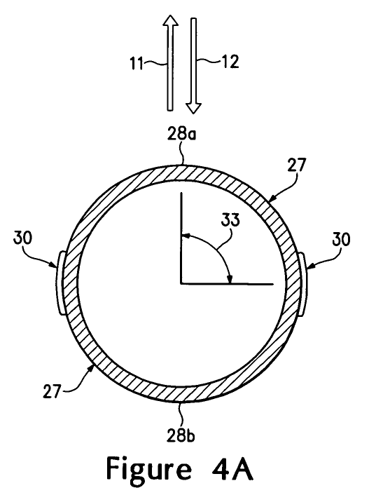

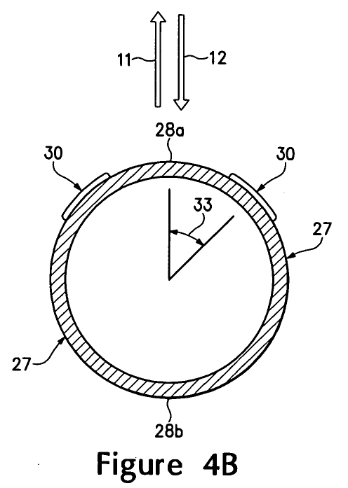

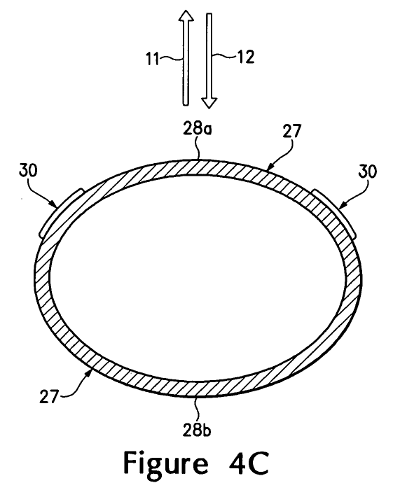

Turbulence generators 30 may be located in a range of 50 degrees and 90 degrees from leading edge 28a of seat tube portion 27. With reference to FIG. 2D, turbulence generators 30 are depicted as being located at 70 degrees from leading edge 28a. That is, angle 33 is approximately 70 degrees. With reference to FIGS. 4A and 4B, angle 33 is respectively depicted as being approximately 90 degrees and 50 degrees. Accordingly, each of these configurations may also impart drag force reduction to seat tube portion 27.

Seat tube portion 27 is depicted a have a pure cylindrical shape in FIGS. 2A-2D. As noted above, however, the term “substantially cylindrical” is defined as an elongate structure having a cross-section with a circular or elliptical configuration. Accordingly, FIG. 4C depicts a substantially cylindrical configuration for seat tube portion 27 that has an elliptical shape.

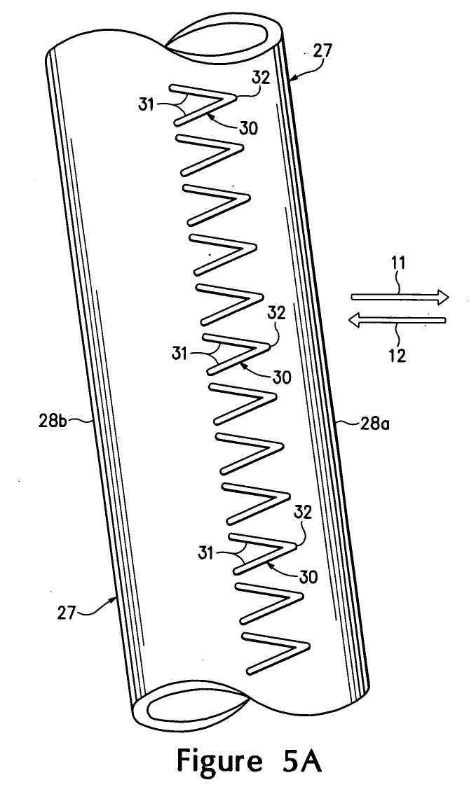

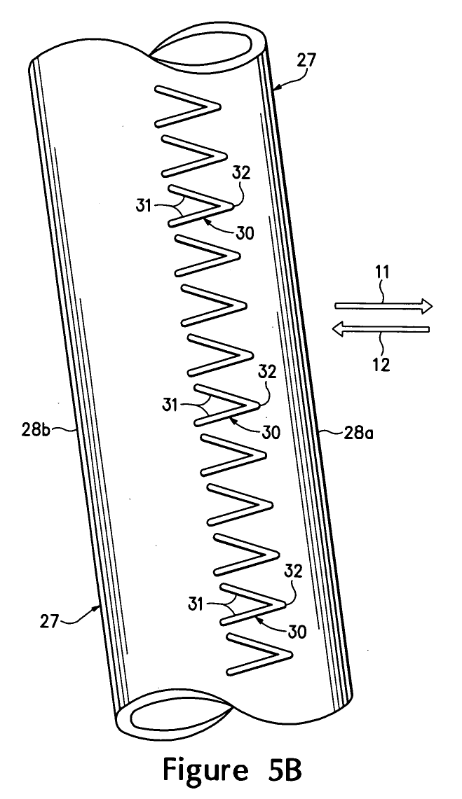

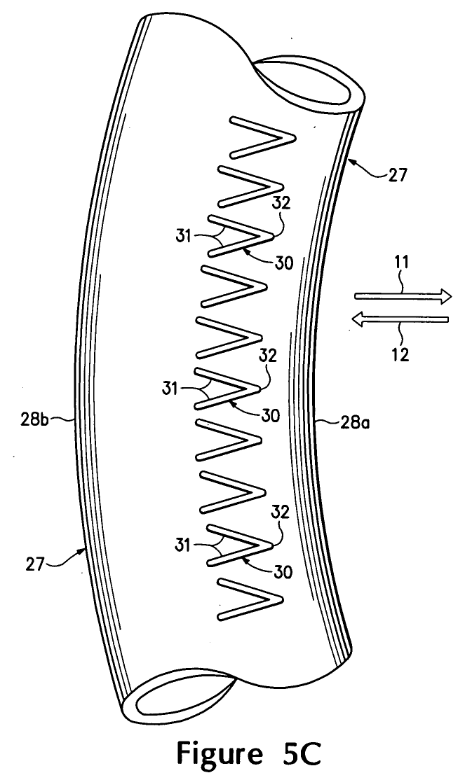

Not all elements of bicycle 10, including seat tube portion 27, are perpendicular to the direction of air flow in a strict mathematical sense. As noted above, however, the term “substantially perpendicular” is defined as being within 30 degrees of a plane that is normal to a direction of air movement. Accordingly, elements of bicycle 10 that vary from the plane that is normal to the direction of air flow (i.e., the direction of arrow 12) by 30 degrees or less may incorporate turbulence generators 30. With reference to FIGS. 5A and 5B, seat tube portion 27 is depicted as being angled with respect to arrow 12, but remains substantially perpendicular to the direction of air flow.

The orientation of turbulence generators 30 may vary in configurations where seat tube portion 27 is angled with respect to arrow 12, but remains substantially perpendicular to the direction of air flow. With reference to FIG. 5A, turbulence generators 30 are oriented as in FIGS. 2A and 2B and are also angled with respect to arrow 12. In FIG. 5B, however, turbulence generators 30 are rotated to face directly into the direction of air flow. The orientation of turbulence generators 30 may, therefore, vary within various configurations. As a further matter, seat tube 27 may have a generally straight configuration, as depicted in FIGS. 1, 2A, and 2B. As depicted in FIG. 5C, however, seat tube 27 may also be curved to exhibit a non-straight configuration. Accordingly, turbulence generators 30 may be located on elements having a variety of shapes or configurations so long as the elements are substantially cylindrical and substantially perpendicular to the direction of air flow.

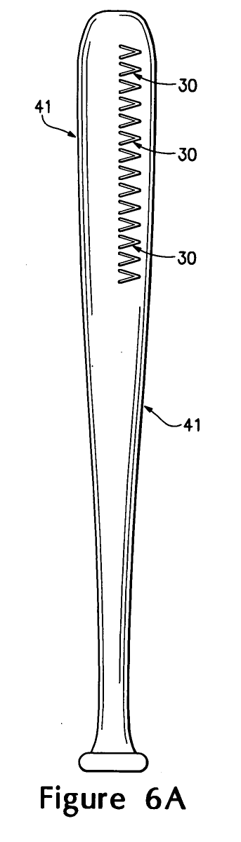

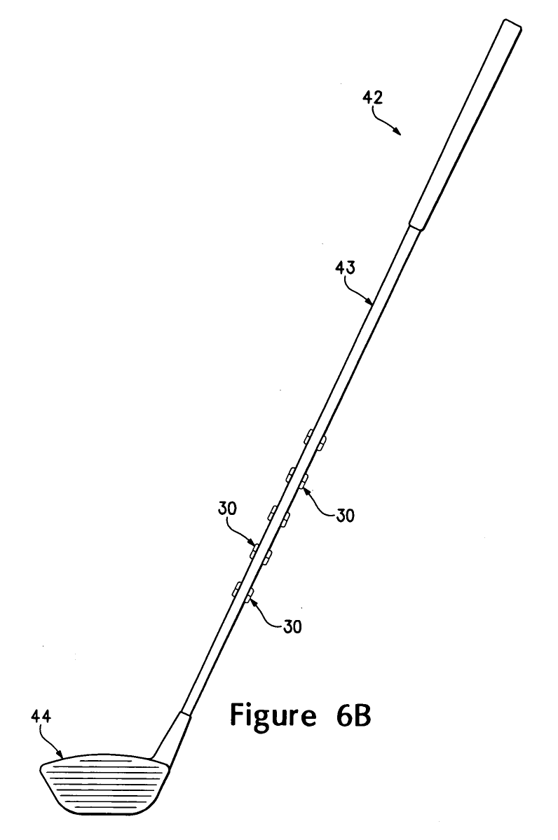

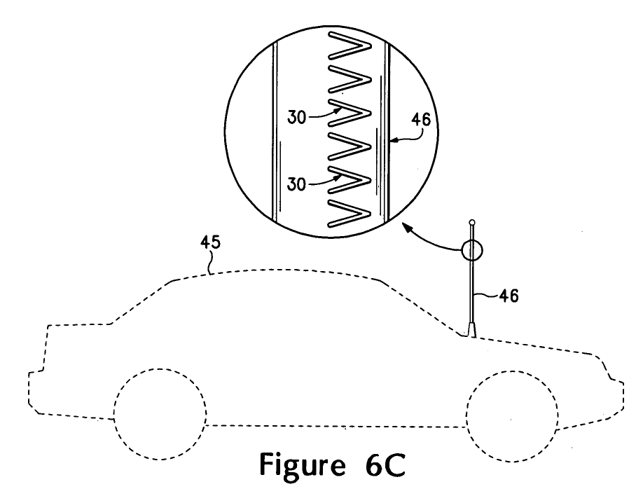

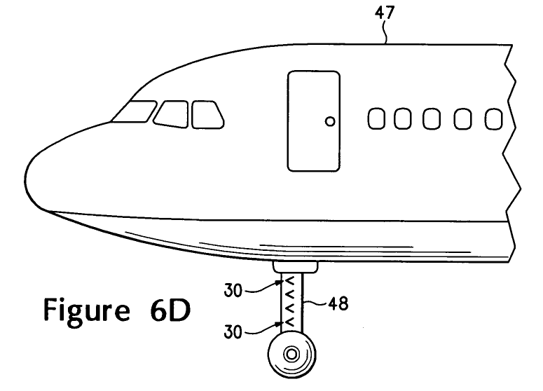

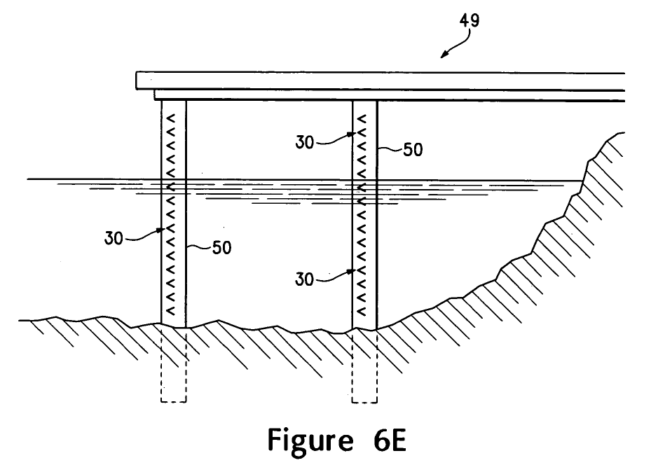

Bicycle 10 provides an example of a suitable article of athletic equipment for turbulence generators 30. With reference to FIGS. 6A and 6B, a plurality of turbulence generators 30 are depicted as being located on a surface of a baseball bat 41. When an individual swings bat 41 at a baseball and makes contact with the baseball, the distance that the baseball travels is at least partially dependent upon the overall velocity of bat 41. Turbulence generators 30 are located on bat 41 to decrease the drag forces upon bat 41, thereby permitting bat 41 to achieve greater velocities. The portion of bat 41 that includes turbulence generators 30 has a substantially cylindrical configuration and is substantially perpendicular to the direction of air flow when the individual swings bat 41. In addition, turbulence generators 30 may be positioned to be in a range of 50 degrees and 90 degrees from a leading edge of bat 41. Accordingly, drag forces acting upon bat 41 may be decreased through the addition of turbulence generators 30.

A golf club 42 is depicted in FIG. 6B as including a shaft 43 and a head 44 secured to an end of shaft 43. Shaft 43 has a substantially cylindrical configuration and is substantially perpendicular to the direction of air flow when the individual swings club 42. By locating turbulence generators 30 on shaft 43 and in a range of 50 degrees and 90 degrees from a leading edge of shaft 43, drag forces acting upon club 42 may be decreased. Examples of other types of athletic equipment that may benefit from turbulence generators 30, in addition to bat 41 and club 42, include hockey sticks, cricket bats, and lacrosse sticks.

In addition to athletic equipment, turbulence generators 30 may be incorporated into a plurality of other applications, including various motorized vehicles (e.g., motorcycles, cars, trucks, airplanes, boats), non-motorized vehicles (e.g., soap-box derby cars, gliders, hang-gliders, sailboats), and columns that support bridges and piers, for example. Accordingly, concepts associated with the turbulence generators 30 may be applied to a variety of consumer and non-consumer products to reduce drag forces.

To further illustrate the manner in which turbulence generators 30 may be incorporated into a variety of products, a vehicle 45 having an antenna 46 is depicted in FIG. 6C. When vehicle 45 moves in a forward direction, air flows around antenna 46 and induces drag on vehicle 45. In order to reduce the overall drag upon vehicle 45, however, antenna 46 is depicted as incorporating a plurality of turbulence generators 30. As an additional example, an airplane 47 is depicted in FIG. 6D as having landing gear 48. In order to reduce the overall drag upon airplane 47 when landing gear 48 is extended, various turbulence generators 30 are located on substantially cylindrical supports for the landing gear wheels.

Turbulence generators 30 may also be utilized on cables, supports, or spans associated with bridges, radio towers, and utility towers, for example. In general, these types of structures are subjected to wind loads, which add to the overall stress of the structures. By adding turbulence generators 30 to the cables, supports, and spans, the wind loads may be effectively decreased.

Each of the examples above disclose turbulence generators 30 in the context of applications where air is fluid causing drag forces. Turbulence generators 30 may also be utilized in the context of other fluids, including water. With reference to FIG. 6E, a pier 49 is depicted as extending from land to an area above water, and various substantially cylindrical supports 50 extend downward through the water and into the earth to support pier 49. Various turbulence generators 30 are located on supports 50 to reduce the drag forces from the water and wind. As another example, a conning tower, antennas, and periscope tubes of a submarine are subjected to drag forces as the submarine passes through the water. Furthermore, fishing nets are subjected to significant drag forces due to water that passes over cables and other portions of the nets. By adding turbulence generators 30 to portions of a submarine, fishing nets, and supports for piers, for example, these drag forces may be effectively decreased.

The invention is disclosed above and in the accompanying drawings with reference to a variety of embodiments. The purpose served by the disclosure, however, is to provide an example of the various features and concepts related to aspects of the invention, not to limit the scope of aspects of the invention. One skilled in the relevant art will recognize that numerous variations and modifications may be made to the embodiments described above without departing from the scope of the invention, as defined by the appended claims.

That which is claimed is:

1. An article comprising:
a substantially cylindrical substrate with a longitudinal axis that is substantially perpendicular to a direction of fluid movement, the substrate having an exterior surface with a leading edge oriented toward the direction of fluid movement and an opposite trailing edge; and
a plurality of turbulence generators secured to the exterior surface of the substrate, at least a portion of the turbulence generators being located in a range of 50 degrees and 90 degrees from the leading edge.

2. The article recited in claim 1, wherein the substrate is a portion of an article of athletic equipment.

3. The article recited in claim 2, wherein the article of athletic equipment is a bicycle.

4. The article recited in claim 2, wherein the portion of the article of athletic equipment is a frame of a bicycle.

5. The article recited in claim 2, wherein the article of athletic equipment is one of a baseball bat and a golf club.

6. The article recited in claim 1, wherein the plurality of turbulence generators include a first row of the turbulence generators and a second row of the turbulence generators.

7. The article recited in claim 6, wherein the first row and the second row are located on opposite sides of the substrate.

8. The article recited in claim 1, wherein the portion of the turbulence generators are joined together.

9. The article recited in claim 1, wherein the portion of the turbulence generators are located at 70 degrees from the leading edge.

10. The article recited in claim 1, wherein the substrate has an elliptical cross-section.

11. An article comprising:
a substantially cylindrical substrate with a longitudinal axis, the substrate having a first side and an opposite second side, the first side defining a first area and the second side defining a second area, the first area being angularly-displaced from the second area in a range of 100 to 180 degrees; and
a plurality of turbulence generators secured to the substrate, each of the turbulence generators having one of a V-shaped configuration and a triangular configuration, and the turbulence generators including:
a first row of the turbulence generators secured to the first area of the substrate, the first row being substantially parallel to the longitudinal axis, and
a second row of the turbulence generators secured to the second area of the substrate, the second row being substantially parallel to the longitudinal axis.

12. The article recited in claim 11, wherein the substrate is a portion of an article of athletic equipment.

13. The article recited in claim 12, wherein the article of athletic equipment is a bicycle.

14. The article recited in claim 12, wherein the portion of the article of athletic equipment is a frame of a bicycle.

15. The article recited in claim 12, wherein the article of athletic equipment is one of a baseball bat and a golf club.

16. The article recited in claim 11, wherein the turbulence generators of the first row are joined together, and the turbulence generators of the second row are joined together.

17. The article recited in claim 11, wherein the first area is angularly-displaced from the second area by 140 degrees.

18. The article recited in claim 11, wherein the substrate has an elliptical cross-section.

19. The article recited in claim 11, wherein the turbulence generators are formed as a one-piece unit with the substrate.

20. An article of athletic equipment, at least a portion of the article of athletic equipment comprising:
a structure having an exterior surface with a substantially cylindrical configuration, the structure having a longitudinal axis that is oriented within 30 degrees of perpendicular to a direction of fluid movement, and the exterior surface having a leading edge oriented toward the direction of fluid movement; and
a plurality of turbulence generators located on the exterior surface, each of the turbulence generators having a V-shaped configuration with a point that is oriented toward the leading edge, the turbulence generators including:
a first row of the turbulence generators, the first row being secured to a first side of the structure, and the first row being located at 70 degrees from the leading edge, and
a second row of the turbulence generators, the second row being secured to a second side of the structure that is opposite the first side, and the second row being located at 70 degrees from the leading edge.

21. The article recited in claim 20, wherein the turbulence generators of the first row are joined together, and the turbulence generators of the second row are joined together.

22. The article recited in claim 20, wherein the substrate has an elliptical cross-section.

23. The article recited in claim 20, wherein the turbulence generators are formed as a one-piece unit with the substrate.

24. A bicycle comprising:
a frame;
a fork that is rotatable with respect to the frame;
a seat positioned on a support that extends upward from the frame;
handlebars that are rotatable with respect to the frame;
a pair of rotatable wheels, one of the wheels being secured to the frame, and another of the wheels being secured to the fork; and
a drive mechanism that moves the bicycle in a first direction to induce fluid flow in a second direction that is opposite the first direction,
at least one of the frame, the fork, the support, and the handlebars having a substantially cylindrical portion with a longitudinal axis that is substantially perpendicular to the second direction, the substantially cylindrical portion having an exterior surface with a leading edge oriented toward the second direction, and at least one of the frame, the fork, the support, and the handlebars having a plurality of turbulence generators secured to the exterior surface, each of the turbulence generators having one of a V-shaped configuration and a triangular configuration, at least a portion of the turbulence generators being located in a range of 50 degrees and 90 degrees from the leading edge.

25. The bicycle recited in claim 24, wherein the plurality of turbulence generators include a first row of the turbulence generators and a second row of the turbulence generators.

26. The bicycle recited in claim 25, wherein the first row and the second row are located on opposite sides of the substantially cylindrical portion.

27. The bicycle recited in claim 24, wherein the portion of the turbulence generators are joined together.

28. The bicycle recited in claim 24, wherein the portion of the turbulence generators are located at 70 degrees from the leading edge.

29. The bicycle recited in claim 24, wherein the substantially cylindrical portion has an elliptical cross-section.

30. An article of athletic equipment, at least a portion of the article of athletic equipment consisting of:
a substantially cylindrical structure with a longitudinal axis that is substantially perpendicular to a direction of fluid movement, and an exterior surface of the cylindrical structure having a leading edge oriented toward the direction of fluid movement; and
a plurality of turbulence generators secured to the exterior surface of the cylindrical structure, each of the turbulence generators having a V-shaped configuration with a point that is oriented toward the leading edge, at least a portion of the turbulence generators being located in a range of 50 degrees and 90 degrees from the leading edge.

31. The article of athletic equipment recited in claim 30, wherein the plurality of turbulence generators include a first row of the turbulence generators and a second row of the turbulence generators.

32. The article of athletic equipment recited in claim 31, wherein the first row and the second row are located on opposite sides of the substantially cylindrical structure.

33. The article of athletic equipment recited in claim 30, wherein the turbulence generators are joined together.

34. The article of athletic equipment recited in claim 30, wherein the portion of the turbulence generators are located at 70 degrees from the leading edge.

35. A method of reducing a drag force, the method comprising steps of:
providing a substantially cylindrical body with a longitudinal axis;
orienting the body such that the longitudinal axis forms an angle less than 30 degrees with a plane that is perpendicular to a direction of fluid flow;
securing a plurality of turbulence generators to a surface of the cylindrical body, each of the turbulence generators having a V-shaped structure, a point of the V-shaped structure being oriented to face a leading edge of the body; and
locating the turbulence generators within a range of 50 degrees and 90 degrees from the leading edge.

36. The method recited in claim 35, wherein the step of providing includes incorporating the body into an article of athletic equipment.

37. The method recited in claim 35, wherein the step of securing including forming a first row of the turbulence generators and a second row of the turbulence generators.

38. The method recited in claim 37, wherein the step of locating includes positioning the first row and the second row on opposite sides of the body.

39. The method recited in claim 35, further including a step of joining the turbulence generators.

40. The method recited in claim 35, wherein the step of locating includes positioning the turbulence generators at 70 degrees from the leading edge.
